(19) United States
(12) Patent Application Publication
(10) Pub. No.: US 2003/0234023 A1
(43) Pub. Date: Dec. 25, 2003

(54) Filter feed on a filter tipping machine

(75) Inventor: Manfred Dombek, Dassendorf (DE)

Correspondence Address: GREENBLUM & BERNSTEIN, P.L.C., 1950 ROLAND CLARKE PLACE, RESTON, VA, 20191, US

(73) Assignee: Hauni Maschinenbau AG, Hamburg (DE)

(21) Appl. No.: 10/464,473

(22) Filed: Jun. 19, 2003

(30) Foreign Application Priority Data
Jun. 21, 2002 (DE) 102 27 933.0

(51) Int. Cl. B31C 13/00

(52) U.S. Cl. 131/88; 131/94; 493/39

(57) ABSTRACT

Process and feed device for feeding filter rods in a machine of the tobacco processing industry that includes at least two magazines for filter rods arranged such that conveyor planes of the filter rods from the at least two magazines are parallel each other and staggered. The instant abstract is neither intended to define the invention disclosed in this specification nor intended to limit the scope of the invention in any way.

### CROSS-REFERENCE TO RELATED APPLICATIONS

The present application claims priority under 35 U.S.C. §119 of German Patent Application No. 102 27 933.0, filed on Jun. 21, 2002, the disclosure of which is expressly incorporated by reference herein in its entirety.

### BACKGROUND OF THE INVENTION

1. Field of the Invention

The present invention relates to a feed device of filter rods in a machine of the tobacco processing industry, in particular a filter tipping machine, with at least two magazines for filter rods and a machine of the tobacco processing industry, in particular a filter tipping machine. The present invention further relates to a process for feeding filter rods from at least two magazines in a machine of the tobacco processing industry, in particular a filter tipping machine.

2. Discussion of Background Information

In Great Britain Application No. GB-A-2 267 021, a filter tipping machine is described in which filter rods are removed respectively from two magazines. After the removal of a first filter rod, this filter rod is cut in the middle and pushed apart in an axially crosswise manner. Subsequently a second filter rod from the other magazine is placed in the middle between the sections of the first filter rod. This filter rod arrangement is subsequently cut, staggered and shuffled respectively on drums. This process—cutting, staggering, and shuffling of the filter pieces—is repeated and thus carried out twice in total. The resulting combination filter from the two different filter rods is subsequently transferred to an assembly drum with cigarette rods.

A filter feed in a filter tipping machine is likewise described in U.S. Pat. No. 5,984,851, in which the filters or filter pieces are also cut, staggered and shuffled several times in succession on the drums. Single or dual filters can be fed to cigarette groups by the disclosed feed device.

### SUMMARY OF THE INVENTION

The present invention provides a simple and variable feed of filter rods from at least two magazines, whereby the filter rods from the respective magazine can be guided separately for as long as possible on their respective conveyor path to the cigarette groups.

In particular, a feed device of the type mentioned at the outset includes magazines arranged such that the conveyor planes of the filter rods are staggered in a parallel manner. The term “conveyor plane” means in particular a plane in which filter rods are removed from a magazine and in which the filter rods are transported in the conveyor direction. From a geometric point of view, the filter rods are respectively arranged perpendicular to the conveyor plane. Several drums can be arranged in the conveyor plane itself so that the filter rods can be transferred from one drum to another.

The invention is based on the idea of utilizing the structural depth of a machine by a spatial staggering of the magazines for the filter rods, so that filter rods are removed from the magazines at the same time. In this manner, the removal points are spatially shifted, i.e., do not lie in one conveyor plane. According to the invention, the conveyor planes of the filter rods are then arranged in a parallel staggered manner to one another.

Several conveyor sections of the filter rods are preferably provided.

In a first conveyor section, relative to the conveyor direction of the filter rods, advantageously at least one removal drum is provided for the filter rods from the magazines and at least one first staggering drum is provided.

In a second conveyor section preferably at least one first shuffling drum is provided.

Furthermore, in particular in the second conveyor section at least one staggering drum and/or at least one second shuffling drum are provided.

In a third conveyor section advantageously at least one accelerating drum or staggering drum is provided.

The invention is based on the further idea that filter rods from the magazines are guided respectively side by side up to the last or penultimate drum of the filter feed parallel and side by side, i.e., staggered axially lengthwise. In order to make this possible, the width of the feed device or the filter tipping machine is important for the arrangement of the drums. Within the scope of the invention it is provided that the drums of the second conveyor section transport the filter rods parallel and side by side respectively at the same time. This means that the filter rods are shuffled at the same time and side by side at least on a first shuffling drum.

In further possible following and variable process flows of the second conveyor section, the filter rods can be staggered at the same time and side by side on the common drum and shuffled onto the likewise common shuffling drum or assembled to produce a filter. The drums of the first conveyor section can be embodied jointly for the filter rods from the different magazines. Moreover, depending on the spatial arrangement of the magazines, the respective drums can be embodied individually for each conveyor path of the filter rods. In the latter case it is necessary for the removal drums and possibly also the staggering drums to be arranged spatially staggered relative to one another for each magazine.

Via the feed device according to the invention, a high variability is achieved since both combination filters and a higher production capacity can be achieved. Utilizing the structural spatial conditions of a machine, the filter rods from different magazines are transported in respectively different planes or on different conveyor paths. According to the invention, the number of pivoted shafts is thereby kept as low as possible, so that the machine drive can be constructed in a simpler manner.

According to an advantageous further development of the invention it is proposed that at least one second staggering drum is arranged in the first conveyor section. After a first staggering in the first conveyor section, at least one second staggering of the filter rods takes place. The distance between two filter rods is thus enlarged in the conveyor direction.

Furthermore, the drums of the first conveyor section advantageously feature essentially the same width.

A reliable guidance of the filter rods in the second conveyor section is ensured if the drums of the second conveyor section essentially feature the same width.

The drums of the first conveyor section and the drums of the second conveyor section preferably feature the same width. In this case the filter rods from all the drums can be guided in the filter tipping machine at the same time, parallel and staggered side by side. To this end the drums are equipped with elongated axes.

In an advantageous further development the removal drums for the first magazine and the removal drum for the second magazine are arranged staggered parallel to one another.

Moreover, according to an alternative embodiment a common removal drum is provided for the first magazine and for the second magazine.

Furthermore according to an advantageous further development of the invention, the staggering drums of the first conveyor section are arranged staggered parallel to one another.

Furthermore, at least one cutting device is provided in the first conveyor section, preferably on at least one removal drum.

In order to produce combination filters, preferably at least one cutting device is provided in the second conveyor section, preferably on the first shuffling drum.

Moreover, the machine of the instant invention for the tobacco processing industry, in particular a filter tipping machine, is equipped with a feed device according to the invention, as described above.

With the process of the type described at the outset, the present invention includes guiding the filter rods in conveyor planes staggered parallel to one another.

The filter rods are advantageously removed respectively from the magazines by a removal drum in the conveying direction in a first conveyor section and staggered by at least one first staggering drum.

The filter rods are preferably shuffled on a first shuffling drum in a second conveyor section.

In a further development of the invention in the second conveyor section the filter rods are staggered by a staggering drum and/or at least partially shuffled by a second shuffling drum.

Furthermore, it is proposed in a further development that the filter rods are fed to cigarette groups in a third conveyor section by an accelerating drum or a staggering drum.

In order to achieve still greater variability in the filter feed in a machine, in the first conveyor section the filter rods are staggered at least one more time by at least one second staggering drum.

Moreover, the filter rods in the first conveyor section, preferably on the removal drum, are preferably cut so that several smaller filter pieces are produced from one removed filter rod.

Combination filters can be easily produced in particular if in the second conveyor section at least part of the filter rods are cut, in particular on the staggering drum.

Before the filter rods or filter pieces are guided further to the accelerating drum and thus to the cigarette groups, according to the invention the filter rods are assembled in the second conveyor section to produce filter groups so that the different filter pieces from several, in particular two, magazines produce one combination filter.

The present invention is directed to a feed device of filter rods in a machine of the tobacco processing industry that includes at least two magazines for filter rods arranged such that conveyor planes of the filter rods from the at least two magazines are parallel each other and staggered.

According to a feature of the invention, the at least two magazines can be staggered in a conveyor direction of the filter rods.

In accordance with another feature of the present invention, the machine can include a filter tipping machine.

The feed device can also include a plurality of conveyor sections for processing the filter rods.

Further, the feed device can include at least one removal drum arranged in a first conveyor section to receive the filter rods from the at least two magazines, and at least one first staggering drum structured and arranged to stagger the filter rods relative to the conveyor direction. Further, the feed device may include at least one second staggering drum arranged in the first conveyor section. The drums of the first conveyor section can have essentially a same width. Still further, the removal drum for a first of the at least two magazines and a removal drum for a second of the at least two magazines can be arranged parallel one another and staggered. At least one cutting device may be located in the first conveyor section, and the at least one cutting device can be located on the at least one removal drum. Moreover, a common removal drum may be provided for the first magazine and for the second magazine. At least one cutting device can be located in the first conveyor section, and the at least one cutting device may be located on the at least one removal drum. Further still, at least one cutting device may be located in the first conveyor section, and the at least one cutting device can be located on the at least one removal drum. The staggering drums of the first conveyor section can be arranged parallel each other and staggered.

According to still another feature of the invention, at least one first shuffling drum can be located in a second conveyor section.

Further, at least one staggering drum can be included, such that at least one of the at least one staggering drum and the at least one second shuffling drum are located in the second conveyor section. The drums of the second conveyor section can have essentially a same width. Moreover, the drums of the first conveyor section and the drums of the second conveyor section have a same width. At least one cutting device may be located in the second conveyor section, and the at least one cutting device can be located on the first shuffling drum.

In accordance with a further feature of the invention, one of at least one accelerating drum or a staggering drum may be located in a third conveyor section.

According to still another feature of the instant invention, a machine of the tobacco processing industry can include the above-described feed device. Further, the machine can include a filter tipping machine.

The present invention is directed to a process for feeding filter rods from at least two magazines. The process includes guiding the filter rods in at least two conveyor planes that are parallel to one another and staggered.

According to a feature of the instant invention, the at least two conveyor planes can be staggered in a conveyor direction.

According to another feature of the invention, the filter rods may be guided in a machine of the tobacco processing industry. Further, the filter rods can be guided in a filter tipping machine.

In accordance with another feature of the present invention, the process can also include removing the filter rods in the at least two magazines by at least one removal drum, and staggering the removed filter rods with at least one first staggering drum. The process can also include shuffling the filter rods in a second conveyor section, downstream of the first conveyor section, on a first shuffling drum. Further, the process can include assembling the filter rods into filter groups in the second conveyor section. Still further, the process may include staggering the filter rods at least one additional time in the first conveyor section by at least one second staggering drum. Moreover, the process can include cutting the filter rods in the first conveyor section. The filter rods can be cut on the removal drum.

Further, the process can also include at least one of staggering the filter rods in the second conveyor section by at least one staggering drum, and shuffling the filter rods at least in part by a second shuffling drum. Moreover, the process can include feeding the filter rods to cigarette groups located in a third conveyor section, downstream of the second conveyor section, by one of an accelerating drum or staggering drum. The process may also include cutting at least a part of the filter rods on the staggering drum in the second conveyor section.

According to another feature of the invention, the process can include feeding the filter rods to cigarette groups by one of an accelerating drum or staggering drum.

In accordance with still another feature, the invention is directed to a machine for performing the above-described process.

The present invention is directed to a feed device that includes a first magazine and a second magazine. The first and second magazines is structured to supply first and second cylindrical elements for conveyance in parallel conveyance directions, and the first and second magazines are structured and arranged to orient axes of the first and second cylindrical elements crosswise to the conveyance direction. Further, the first and second magazines are arranged so that the first cylindrical rods are supplied to be axially offset with respect to the second cylindrical rods.

In accordance with a feature of the invention, at least one removal device may be structured to receive the first and second cylindrical rods from the first and second magazines. The at least one removal device may be common to the first and second magazines. Moreover, the at least one removal device can include a first removal roll associated with the first magazine and a second removal roll associated with the second magazine, and the first and second removal rolls may be oriented parallel each other but be axially offset from each other.

According to another feature of the invention, the first and second cylindrical elements can be supplied by the first and second magazines are different from each other. The first and second cylindrical elements can be different types of filter rods.

The present invention is directed to a machine for feeding filter rods. The machine includes at least two magazines structured and arranged to supply filter rods along parallel conveyance paths that are spatially offset from each other in a conveyance direction.

The instant invention is directed to a process for feeding cylindrical elements. The process includes supplying first and second cylindrical elements in parallel conveyance directions. The first and second cylindrical elements are supplied so that their respective axes are oriented crosswise to the conveyance direction. The process also includes arranging the first and second cylindrical rods so that the first cylindrical rods are axially offset with respect to the second cylindrical rods.

According to a feature of the invention, the process can also include receiving the first and second cylindrical rods in at least one removal device. The at least one removal device can be common to the first and second magazines. Moreover, the at least one removal device can include a first removal roll associated with the first magazine and a second removal roll associated with the second magazine, and the first and second removal rolls can be oriented parallel each other but be axially offset from each other.

In accordance with still another feature of the invention, the supplied first and second cylindrical elements can be different from each other. The first and second cylindrical elements may be different types of filter rods.

Moreover, an apparatus for forming a filter can include at least two magazines and a first conveyance section having at least one removal drum to receive the cylindrical elements, at least one cutting device to cut the cylindrical elements, and at least one staggering drum to stagger the cut cylindrical elements. The apparatus also includes a second conveyance section having at least one shuffling drum to rearrange the staggered cut cylindrical elements, at least one second staggering drum to second stagger the shuffled and staggered cut cylindrical elements; and at least one second shuffling drum to shuffle the second staggered, shuffled and staggered cut cylindrical elements. The apparatus also includes a third conveyance section comprising an accelerating roll structured and arranged to position the second shuffled, second staggered, shuffled and staggered cut cylindrical elements.

The present invention is directed to a process for feeding filter rods, that includes supplying filter rods along parallel conveyance paths that are spatially offset from each other in a conveyance direction.

In accordance with still yet another feature of the invention, a filter tipping machine includes the above-noted apparatus and also includes a device for joining a cut tobacco rod to each end of each second shuffled, second staggered, shuffled and staggered cut cylindrical elements, and a filter cutting device arranged to divide each second shuffled, second staggered, shuffled and staggered cut cylindrical elements to form two filter tipped cigarettes. Further, the second conveyance section can include at least one second cutting device arranged to second cut at least part of the shuffled and staggered cut cylindrical elements. The accelerating roll positions a shuffled and staggered cut cylindrical element between two second cut, shuffled and staggered cut cylindrical elements.

Other exemplary embodiments and advantages of the present invention may be ascertained by reviewing the present disclosure and the accompanying drawing.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 illustrates a filter tipping machine with a feed device according to the prior art;

FIG. 2 illustrates a detailed view of a feed device according to the prior art;

FIG. 3 illustrates an exemplary embodiment of a feed device according to the instant invention;

FIG. 4 illustrates a plan view of an arrangement of the two magazines in accordance with the invention;

FIG. 5 illustrates a second exemplary embodiment of a feed device according to the invention;

FIG. 6 diagrammatically illustrates a positioning of the filter segments according to the device depicted in FIG. 3;

FIG. 7 diagrammatically illustrates a positioning of the filter segments according to the device depicted in FIG. 5; and

FIG. 8 illustrates an exemplary embodiment of a feed device in accordance with the instant invention for a double-track filter tipping machine.

### DETAILED DESCRIPTION OF THE PRESENT INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

In the following description of the figures the same or the same kind of elements are designated by the same reference numbers, so that a new introduction of them is omitted.

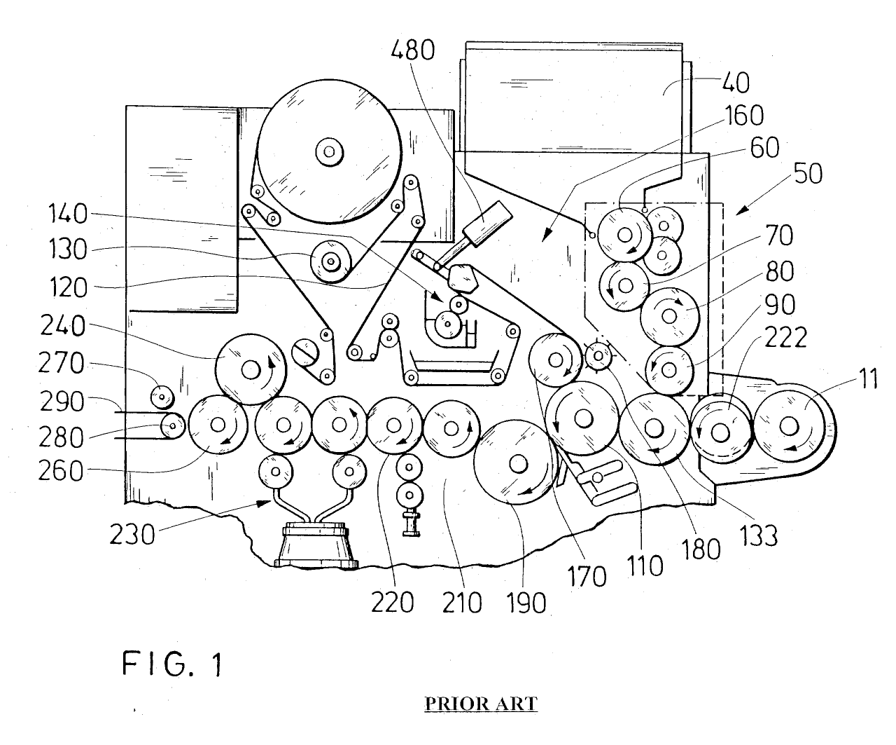

FIG. 1 shows the front view of a known filter tipping machine of the MAX type by Hauni Maschinenbau AG, Hamburg, Germany. This machine features the following details: an intake drum 111 transfers the cigarettes produced in a cigarette production machine to two staggering drums 222, which deliver the cigarettes fed in a staggered manner in staggers and in rows of two each with a gap between the cigarettes to an assembly drum 333.

The filter rods arrive from a magazine 40 on a removal drum 60, are there cut into filter plugs of double unit length, staggered on a staggering drum 70, aligned by a shuffling drum 80 to produce a row of plugs arranged one behind the other and placed by an accelerating drum 90 into the gaps of the cigarette rows on the assembly drum 333. The cigarette-filter-cigarette groups are pushed together and accepted by a transfer drum 110.

A coating paper web 120 drawn from a coating paper bobbin 130 is glued by a gluing device 140 and then cut into coating strips in a cutting device 160 on a severing drum 170 by the knives of a knife drum 180. The severed coating strips are adhered to the cigarette-filter-cigarette groups on the transfer drum 110 and rolled around the cigarette filter groups on a rolling drum 190.

The finished double filter cigarettes are fed via a drying drum 210 to a severing drum 220 and on this are made into individual filter cigarettes by the filter plugs being cut in the middle. A turnover device 230 turns the filter cigarette row around and at the same time transfers it into the filter cigarette row running through that has not been turned around. The filter cigarettes reach an ejecting drum 260 via a testing drum 240. A distributing drum 280 interacting with a braking drum 270 places the filter cigarettes on a distributing belt 290.

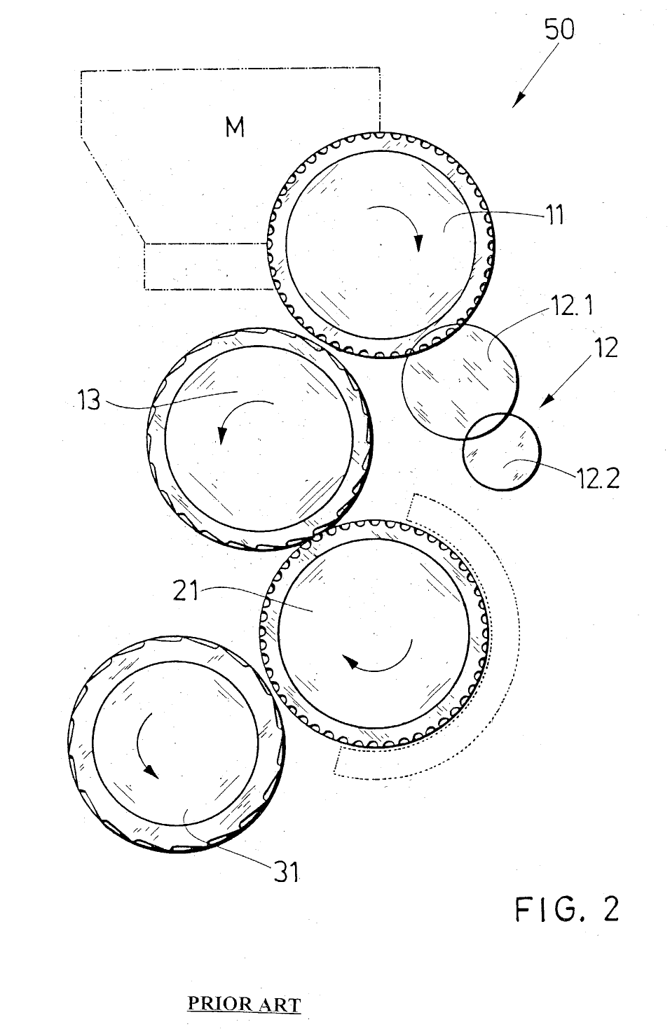

FIG. 2 shows an enlarged view of a feed device 50 according to the prior art. The filter rods are removed from a magazine M by removal drum 11 and cut by the cutting device 12 that comprises a knife 12.1 and a grinding disk 12.2 for regrinding the knife 12.1. Subsequently the cut filter pieces are staggered on the staggering drum 13, transferred to a shuffling drum 21 on which the filter pieces are arranged in one row one behind the other. The filter rods are subsequently transferred to an accelerating drum 31 and fed to the cigarette groups.

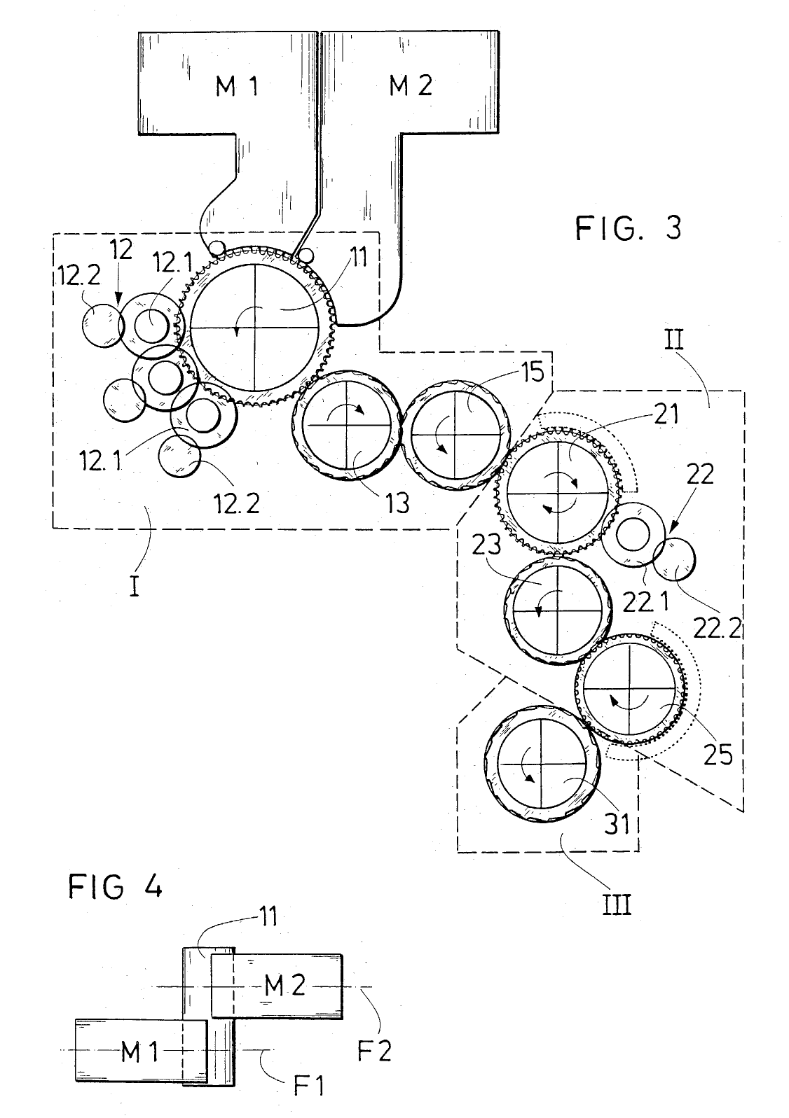

FIG. 3 shows a first exemplary embodiment of a feed device according to the invention. Filter rods are removed from two magazines M1, M2 at the same time by a removal drum 11. The magazines M1 and M2 are arranged staggered relative to one another in the direction perpendicular to the drawing plane (cf. FIG. 4).

FIG. 4 shows the spatial arrangement of the magazines M1 and M2 in a diagrammatic plan view. The magazines M1 and M2 with their conveyor planes F1, F2 are offset or staggered parallel to one another. The filter rods in the magazines are removed from the magazines M1, M2 by the removal roller 11 at two points arranged one behind the other in the circumferential direction. The removal of the filter rods from the magazines M1 and M2 takes place at the same time in the conveyor planes F1, F2 staggered parallel with respect to one another. The filter rods are arranged respectively axially lengthwise and at a predetermined distance from one another. Within the scope of the invention the magazines M1, M2 can also be embodied one behind the other, so that the filter rods can be removed from the magazines M1, M2 at the same point in the circumferential direction of the removal drum.

After the removal, the filter rods are respectively cut at the cutting devices 12. The cut filter rods are staggered on a staggering drum 13 and subsequently on another second staggering drum 15. The removal drum 11 and the staggering drums 13, 15 form the first conveyor section I of the filter rods. The filter pieces staggered twice are pushed together in the following conveyor section II into respectively one row of filter pieces one behind the other. In other words: two separate rows of filter pieces are formed on a common shuffling drum 21. In order to produce combination filters, one row of the filter pieces is cut with a cutting device 22. The cutting device 22 comprises a knife 22.1 that is kept continuously sharp with a grinding disk 22.2. The two rows of filter pieces formed on the shuffling drum 21 are staggered by the staggering drum 23 and transferred to the second shuffling drum 25. The filter pieces are shuffled once again on the shuffling drum 25 so that the staggered shuffled filter pieces are assembled into a filter of double-unit length by the accelerating drum 31, which is embodied as a staggering drum.

In an alternative embodiment the production capacity can be increased while omitting the cutting device 22 if filter rods of the same type are removed from the magazines M1 and M2.

The acceleration and staggering of the filter pieces taken over by the shuffling drum 25 forms the third conveyor section III of the filter plugs or pieces. Whereas in the conveyor sections I and II the drums feature respectively two rows of filter rods or pieces, only one row of filter pieces or filters is still present on the accelerating drum 31.

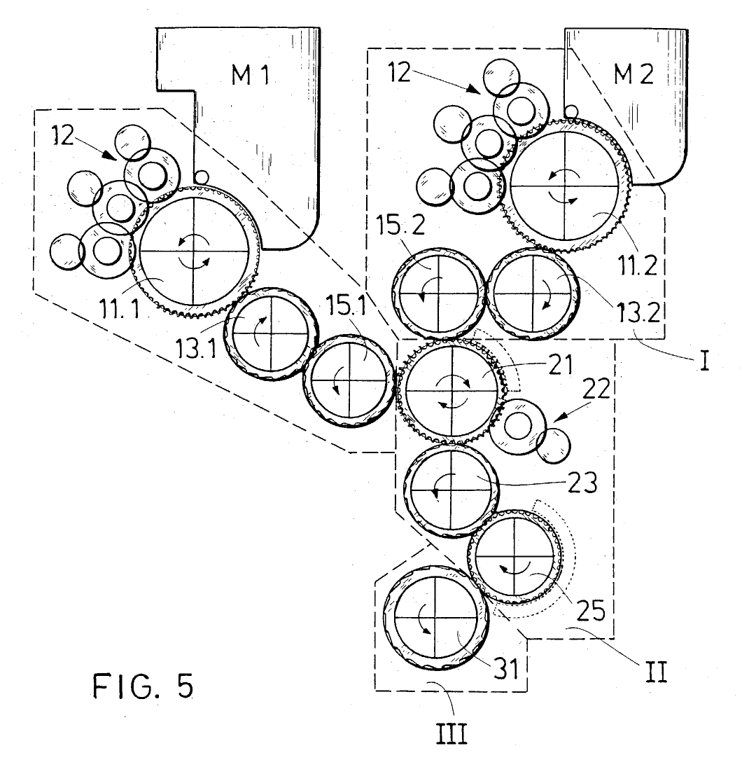

FIG. 5 shows another alternative exemplary embodiment according to the invention in side view. In the first conveyor section I the filter rods from the magazine M1 are hereby transported separately from the filter rods from the magazine M2 to the common drums of the conveyor sections II and III. The conveyor section I of the filter rods from the magazine M1 takes place via the removal drum 11.1 and the two staggering drums 13.1 and 15.1. The conveyor drums—removal drum 11.2, staggering drum 13.2, staggering drum 15.2—staggered spatially, axially crosswise relative to these drums, convey the filter rods from the magazine M2 to the common shuffling drum 21 of the second conveyor section II on a conveyor path staggered in a parallel manner.

Analogously to the first exemplary embodiment according to FIG. 3, in this second example the filter rods from the magazines M1 and M2 are likewise transported respectively separately and parallel to one another in the respective conveyor section I. The following drums of the conveyor sections II and III correspond to the drums from the first exemplary embodiment (FIG. 3).

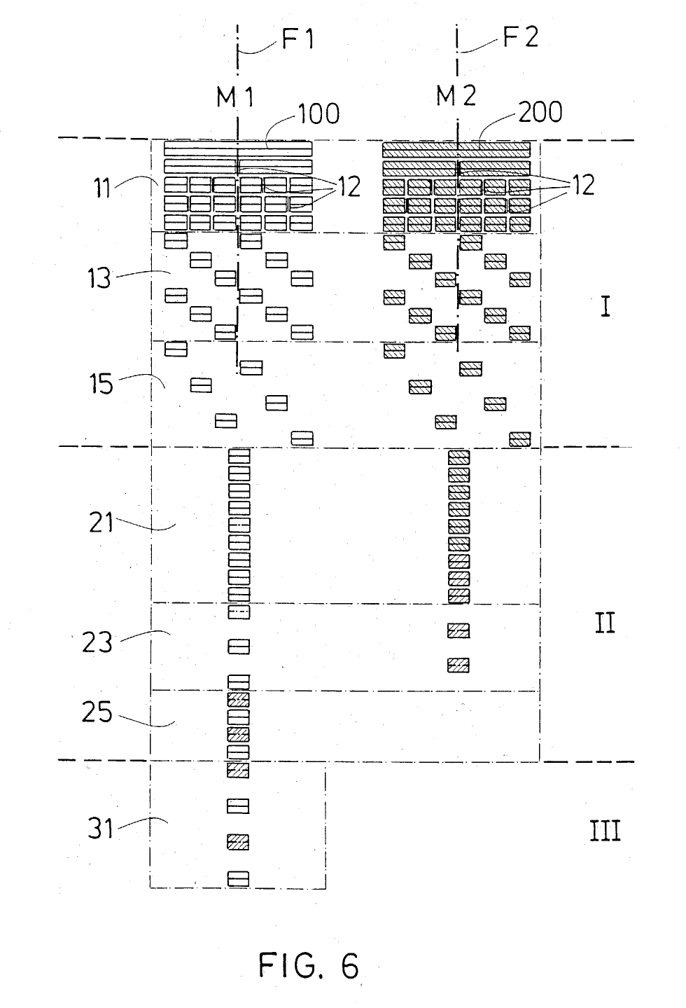

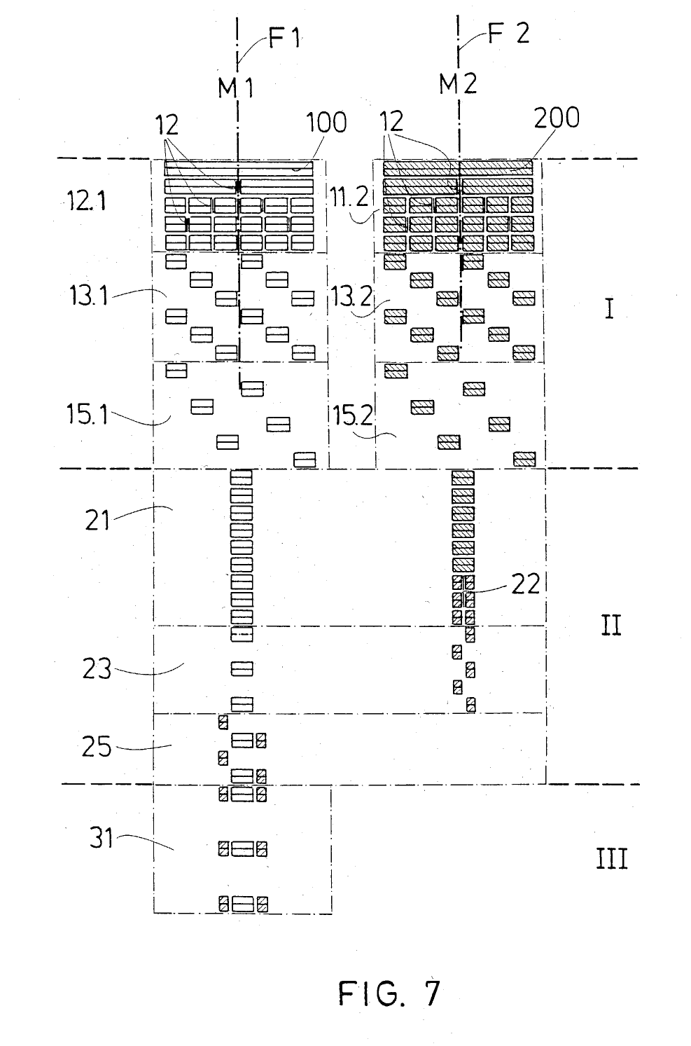

FIGS. 6 and 7 show respectively diagrammatic arrangements of filter rods or pieces according to their position in the respective drums from FIG. 3 or FIG. 5. For reasons of clarity the filter rods from the two magazines M1, M2 are graphically represented in a different way. The filter rods 100 not cross-hatched are removed from the magazine M1 and the cross-hatched filter rods 200 from the magazine M2. The filter rods 100, 200 are arranged respectively perpendicular to their conveyor plane F1, F2.

After the removal of the filter rods 100, 200 by the common removal drum 11, these filter rods 100, 200 are cut by cutting devices 12 into filter pieces of equal length. The filter pieces from both magazines M1, M2 are subsequently staggered. Depending on requirements, it is necessary to stagger the filter pieces only once or several times, so that the cut filter pieces 100, 200 can be arranged in one row on the first shuffling drum of the conveyor section II. The parallel rows of filter pieces 100, 200 on the shuffling drum 21 are staggered in an axially crosswise manner by staggering drum 23 so that on a following second shuffling drum 25 of the conveyor section II the filter pieces 100, 200 from the two magazines M1, M2 can be arranged in one row. Subsequently a staggering and feed to the cigarette groups occurs by the common accelerating drum or staggering drum 31 in the third conveyor section III.

In the exemplary embodiment according to FIG. 6 the production capacity of the filter tipping machine can be increased since by the double-wide drums of the conveyor sections I and II accordingly twice as many filter pieces can be fed to the cigarette groups.

Filter pieces 100, 200 are removed from the magazines M1 and M2 by removal drum 11. The filter rods 100, 200, with 6-fold unit length in the present case, are cut into six filter pieces of equal length by the cutting device 12. Within the scope of the invention it is possible, depending on the cutting devices, for multiple filter pieces, preferably 4- to 12-fold, to be cut. The cut filter pieces are respectively staggered on the following first staggering drum 13, whereby respectively two filter pieces per conveyor plane are arranged at a predetermined distance from one another in a flute of the staggering drum 13. The filter pieces are staggered once again by the second staggering drum 15 so that only one filter piece is arranged per conveyor plane in each flute of the staggering drum. The procedures described above are carried out in a parallel manner both for the filter pieces 100 in the conveyor plane F1 and for the filter pieces 200 in the conveyor plane F2. In the following conveyor plane II the filter pieces are first arranged on a common shuffling drum 21 in one row, staggered by a staggering drum 23. On the following shuffling drum 25 the filter pieces are formed into one row of filter pieces lying one behind the other in the different conveyor planes F1, F2. In the following conveyor section III the filter pieces from the different conveyor planes F2 are accelerated or staggered.

According to the exemplary embodiment in FIG. 7, the filter rods 100, 200 from the two magazines M1, M2 are conveyed parallel to one another in the conveyor section I. Conveying the filter rods or pieces 100, 200 is carried out by spatially separate drums staggered axially crosswise and staggered parallel to one another (cf. FIG. 5). The filter rods 100, 200 are removed from the magazines M1 and M2 respectively by the removal drums 11.1, 11.2 and cut. Depending on the use and the filter rod length, the filter rods 100, 200 are subsequently staggered respectively in their conveyor planes F1, F2 several times by staggering drums 13.1, 13.2, 15.1, 15.2 in the conveyor section I. Subsequently the filter pieces 100, 200 from the two magazines are respectively arranged one behind the other in one row on the common shuffling drum 21 of the conveyor section II. In order to produce combination filters, the filter pieces 200 of one row are cut in the middle by a cutting device 22. Subsequently a staggering occurs on the staggering drum 23 and a shuffling of the filter pieces on the shuffling drum 25. The assembly of the double-length and symmetrical combination filter occurs on the staggering or accelerating drum 31 of the conveyor section III.

In order to make it possible to guide the filter rods 100, 200 from at least two magazines M1, M2 parallel next to one another in the conveyor planes F1, F2 up to the last or penultimate drum of the filter feed, it is provided according to the invention to carry out the filter feed on widened drums utilizing the spatial depth of a filter tipping machine. The filter rods are hereby guided in different conveyor planes.

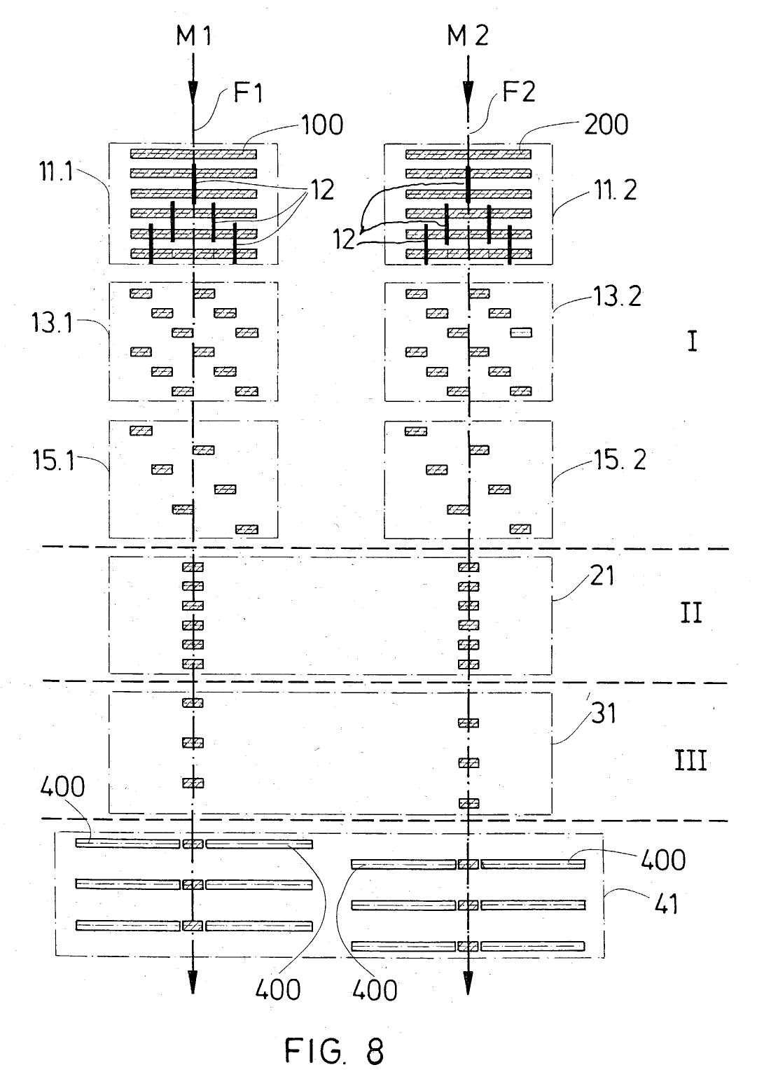

FIG. 8 shows in diagrammatic form another example of a feed device for a double-track filter tipping machine. The filter rods 100 or 200 are removed by removal drums 11.1, 11.2 from the magazines M1, M2 staggered parallel to one another and cut several times with the aid of the cutting devices 12 arranged on the removal drums 11.1, 11.2, so that during transfer of the cut filter pieces from the removal drums 11.1, 11.2 to the staggering drums 13.1, 13.2, filter pieces or filter plugs of double unit length are prepared that are placed in the gaps of cigarette rows or cut tobacco rods on an assembly drum 41.

After a first staggering of the filter pieces of double unit length on the first staggering drums 13.1 or 13.2, the filter pieces are staggered a second time on the staggering drums 15.1 or 15.2 in the first conveyor section I. In the following second conveyor section II the filter pieces are arranged in the conveyor planes F1 or F2 in one row on the shuffling drum 21. Afterwards the parallel rows of filter pieces are transferred to an accelerating drum 31 of the third conveyor section III and staggered on this accelerating drum 31 or staggering drum, so that the filter pieces are arranged parallel and staggered relative to one another in the conveyor planes F1 or F2.

After the staggering of the filter pieces in the third conveyor section III, the filter pieces are fed to the double-wide assembly drum 41 of the double-track filter tipping machine and placed in the gaps between two cut tobacco rods 400 arranged axially crosswise relative to one another, so that cigarette-filter piece-cigarette groups are formed. With a double-track filter tipping machine two filter pieces of double unit length are placed parallel or parallel in a staggered manner between two cut tobacco rods respectively.

In an alternative of a double-track filter tipping machine (not shown here) the installation of the accelerating drum or staggering drum 31 in the third conveyor section is omitted, so that the filter rods of the shuffling drum 21 arranged side by side in parallel rows are transferred directly to an assembly drum in the second conveyor section. On this assembly drum in total four cut tobacco rods are arranged in two parallel rows in the axially crosswise direction of the drum.

For a double-track filter tipping machine, the shuffling drum 21 of the second conveyor section II and/or the accelerating drum 31 of the third conveyor section III feature the double width. In a further exemplary embodiment not shown here the drums of the first conveyor section III are likewise embodied with the double width.

With a double-track filter tipping machine the filter rods are conveyed respectively parallel and side by side in two parallel conveyor planes up to the double-width assembly drum, so that the production capacity of a double-track filter tipping machine is increased by the feed device according to the invention. Moreover, the number of pivoted shafts of the transport drums is kept low, so that the drive of the machine is simple in construction.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

### List of Reference Numbers

| | |
|---|---|
| 11, 11.1, 11.2 | Removal drum |
| 12 | Cutting device |
| 12.1 | Knife |
| 12.2 | Grinding disk |
| 13, 13.1, 13.2 | Staggering drums |
| 15, 15.1, 15.2 | Staggering drums |
| 21 | Shuffling drum |
| 22 | Cutting device |
| 22.1 | Knife |
| 22.2 | Grinding disk |
| 23 | Staggering drum |
| 25 | Shuffling drum |
| 31 | Accelerating drum |
| 40 | Magazine |
| 41 | Assembly drum |
| 50 | Feed device |
| 60 | Removal drum |
| 70 | Staggering drum |
| 80 | Shuffling drum |
| 90 | Accelerating drum |
| 100 | Filter rods |
| 110 | Transfer drum |
| 111 | Intake drum |
| 120 | Coating paper web |
| 130 | Coating paper bobbin |
| 140 | Gluing device |
| 160 | Cutting device |
| 170 | Severing drum |
| 180 | Knife drum |
| 190 | Rolling drum |
| 200 | Filter rods |
| 210 | Drying drum |
| 220 | Severing drum |
| 222 | Staggering drum |
| 230 | Turnover device |
| 240 | Testing drum |
| 260 | Ejecting drum |
| 270 | Braking drum |
| 280 | Distributing drum |
| 290 | Distributing belt |
| 333 | Assembly drum |
| 400 | Cut tobacco rods |
| F1 | Conveyor plane 1 |
| F2 | Conveyor plane 2 |
| M | Magazine |
| M1 | Magazine 1 |
| M2 | Magazine 2 |
| I | Conveyor section I |
| II | Conveyor section II |
| III | Conveyor section III |

What is claimed:

1. A feed device of filter rods in a machine of the tobacco processing industry comprising:
at least two magazines for filter rods arranged such that conveyor planes of the filter rods from said at least two magazines are parallel each other and staggered.

2. The feed device in accordance with claim 1, wherein said at least two magazines are staggered in a conveyor direction of the filter rods.

3. The feed device in accordance with claim 1, wherein said machine comprises a filter tipping machine.

4. The feed device in accordance with claim 1, further comprising a plurality of conveyor sections for processing the filter rods.

5. The feed device in accordance with claim 1, further comprising at least one removal drum arranged in a first conveyor section to receive the filter rods from the at least two magazines; and
at least one first staggering drum structured and arranged to stagger the filter rods relative to the conveyor direction.

6. The feed device in accordance with claim 5, further comprising at least one second staggering drum arranged in said first conveyor section.

7. The feed device in accordance with claim 6, wherein said drums of said first conveyor section have essentially a same width.

8. The feed device in accordance with claim 5, wherein said removal drum for a first of said at least two magazines and a removal drum for a second of said at least two magazines are arranged parallel one another and staggered.

9. The feed device in accordance with claim 8, further comprising at least one cutting device located in said first conveyor section.

10. The feed device in accordance with claim 9, wherein said at least one cutting device is located on said at least one removal drum.

11. The feed device in accordance with claim 5, wherein a common removal drum is provided for the first magazine and for the second magazine.

12. The feed device in accordance with claim 11, further comprising at least one cutting device located in said first conveyor section.

13. The feed device in accordance with claim 12, wherein said at least one cutting device is located on said at least one removal drum.

14. The feed device in accordance with claim 5, further comprising at least one cutting device located in said first conveyor section.

15. The feed device in accordance with claim 14, wherein said at least one cutting device is located on said at least one removal drum.

16. The feed device in accordance with claim 5, wherein said staggering drums of said first conveyor section are arranged parallel each other and staggered.

17 The feed device in accordance with claim 1, further comprising at least one first shuffling drum located in a second conveyor section.

18 The feed device in accordance with claim 17, further comprising at least one staggering drum,
wherein at least one of said at least one staggering drum and said at least one second shuffling drum are located in said second conveyor section.

19. The feed device in accordance with claim 18, wherein said drums of said second conveyor section have essentially a same width.

20. The feed device in accordance with claim 19, wherein said drums of said first conveyor section and said drums of said second conveyor section have a same width.

21. The feed device in accordance with claim 17, further comprising at least one cutting device located in said second conveyor section.

22. The feed device in accordance with claim 21, wherein said at least one cutting device is located on said first shuffling drum.

23. The feed device in accordance with claim 1, further comprising one of at least one accelerating drum or a staggering drum located in a third conveyor section.

24. A machine of the tobacco processing industry comprising a feed device in accordance with claim 1.

25. The machine in accordance with claim 24, wherein said machine comprises a filter tipping machine.

26. A process for feeding filter rods from at least two magazines, comprising:
guiding the filter rods in at least two conveyor planes that are parallel to one another and staggered.

27. The process in accordance with claim 26, wherein the at least two conveyor planes are staggered in a conveyor direction.

28. The process in accordance with claim 26, wherein the filter rods are guided in a machine of the tobacco processing industry.

29. The process in accordance with claim 26, wherein the filter rods are guided in a filter tipping machine.

30. The process in accordance with claim 26, further comprising:
removing the filter rods in the at least two magazines by at least one removal drum; and
staggering the removed filter rods with at least one first staggering drum.

31. The process in accordance with claim 30, further comprising shuffling the filter rods in a second conveyor section, downstream of the first conveyor section, on a first shuffling drum.

32. The process in accordance with claim 31, further comprising assembling the filter rods into filter groups in the second conveyor section.

33. The process in accordance with claim 30, further comprising staggering the filter rods at least one additional time in the first conveyor section by at least one second staggering drum.

34. The process in accordance with claim 30, further comprising cutting the filter rods in the first conveyor section.

35. The process in accordance with claim 34, wherein the filter rods are cut on the removal drum.

36. The process in accordance with claim 26, further comprising at least one of:
staggering the filter rods in the second conveyor section by at least one staggering drum; and
shuffling the filter rods at least in part by a second shuffling drum.

37. The process in accordance with claim 36, further comprising feeding the filter rods to cigarette groups located in a third conveyor section, downstream of the second conveyor section, by one of an accelerating drum or staggering drum.

38. The process in accordance with claim 36, further comprising cutting at least a part of the filter rods on the staggering drum in the second conveyor section.

39. The process in accordance with claim 26, further comprising feeding the filter rods to cigarette groups by one of an accelerating drum or staggering drum.

40. A filter formed by the process in accordance with claim 26.

41. A feed device comprising:
a first magazine and a second magazine, said first and second magazines being structured to supply first and second cylindrical elements for conveyance in parallel conveyance directions, and said first and second magazines being structured and arranged to orient axes of the first and second cylindrical elements crosswise to said conveyance directions; and
said first and second magazines being arranged so that the first cylindrical elements are supplied to be axially offset with respect to the second cylindrical elements.

42. The feed device in accordance with claim 41, further comprising at least one removal device structured to receive the first and second cylindrical elements from said first and second magazines.

43. The feed device in accordance with claim 42, wherein said at least one removal device is common to said first and second magazines.

44. The feed device in accordance with claim 42, wherein said at least one removal device comprises a first removal roll associated with said first magazine and a second removal roll associated with said second magazine, and
said first and second removal rolls are oriented parallel each other but are axially offset from each other.

45. The feed device in accordance with claim 41, wherein the first and second cylindrical elements supplied by said first and second magazines are different from each other.

46. The feed device in accordance with claim 45, wherein the first and second cylindrical elements are different types of filter rods.

47. A machine for feeding filter rods, comprising:
at least two magazines structured and arranged to supply filter rods along parallel conveyance paths that are spatially offset from each other in a conveyance direction.

48. A process for feeding cylindrical elements, comprising:
supplying first and second cylindrical elements in parallel conveyance directions, wherein the first and second cylindrical elements are supplied so that their respective axes are oriented crosswise to the conveyance directions; and
arranging the first and second cylindrical elements so that the first cylindrical elements are axially offset with respect to the second cylindrical elements.

49. The process in accordance with claim 48, further comprising receiving the first and second cylindrical elements in at least one removal device.

50. The process in accordance with claim 49, wherein the at least one removal device is common to the first and second magazines.

51. The feed device in accordance with claim 49, wherein the at least one removal device comprises a first removal roll associated with the first magazine and a second removal roll associated with the second magazine, and
the first and second removal rolls are oriented parallel each other but are axially offset from each other.

52. The process in accordance with claim 48, wherein the supplied first and second cylindrical elements are different from each other.

53. The process in accordance with claim 52, wherein the first and second cylindrical elements are different types of filter rods.

54. An apparatus for forming a filter, comprising:
at least two magazines;
a first conveyance section comprising:
at least one removal drum to receive the cylindrical elements;
at least one cutting device to cut the cylindrical elements; and
at least one staggering drum to stagger the cut cylindrical elements;
a second conveyance section comprising:
at least one shuffling drum to rearrange the staggered cut cylindrical elements;
at least one second staggering drum to second stagger the shuffled and staggered cut cylindrical elements; and
at least one second shuffling drum to shuffle the second staggered, shuffled and staggered cut cylindrical elements; and
a third conveyance section comprising an accelerating roll structured and arranged to position the second shuffled, second staggered, shuffled and staggered cut cylindrical elements.

55. A process for feeding filter rods, comprising:
supplying filter rods along parallel conveyance paths that are spatially offset from each other in a conveyance direction.

56. A filter tipping machine comprising the apparatus of claim 54, further comprising:
a device for joining a cut tobacco rod to each end of each second shuffled, second staggered, shuffled and staggered cut cylindrical elements; and
a filter cutting device arranged to divide each second shuffled, second staggered, shuffled and staggered cut cylindrical elements to form two filter tipped cigarettes.

57. The filter tipping machine in accordance with claim 56, said second conveyance section comprising at least one second cutting device arranged to second cut at least part of the shuffled and staggered cut cylindrical elements,
wherein said accelerating roll positions a shuffled and staggered cut cylindrical element between two second cut, shuffled and staggered cut cylindrical elements.
